(19) United States
(12) Patent Application Publication
(10) Pub. No.: US 2019/0147451 A1
(43) Pub. Date: May 16, 2019

(54) Collaborate Fraud Prevention

(71) Applicant: BehavioSec Inc, San Francisco, CA (US)

(72) Inventors: Ingo Deutschmann, Frankleben (DE); Per Burstrom, Lulea (SE); Philip Lindblad, Lulea (SE); David Julitz, Weissenfels (DE)

(21) Appl. No.: 16/246,974

(22) Filed: Jan. 14, 2019

Related U.S. Application Data
(63) Continuation-in-part of application No. 16/200,740, filed on Nov. 27, 2018.

(51) Int. Cl. G06Q 20/40; G06F 21/62; H04L 29/06; G06Q 20/10

(52) U.S. Cl. CPC G06Q 20/4016; G06F 21/6254; G06Q 2220/00; G06Q 20/108; G06F 2221/2115; H04L 63/102

(57) ABSTRACT

Two user-authenticated sessions are compared between two different servers or users of two different financial institutions. Based on comparisons of sanitized key press timings, position or motion-related inputs, and other inputs it is determined that the sessions were/are with a same user. When this user is identified as a fraudulent actor or malfeasant with one server or banking institution, this data is shared, without sharing confidential information, with the other server or financial institution so that despite a lack of identifying the user himself/herself, the second server or financial institution can modify data sent to this user to prevent fraud and unauthorized access to data of another.

### FIELD OF THE DISCLOSED TECHNOLOGY

The disclosed technology relates to a method and devices for sharing of sanitized data to determine fraud, such as specifically in banking systems.

### BACKGROUND OF THE DISCLOSED TECHNOLOGY

For as long as banks have been around, there has been fraud. Banks and other institutions that provide services that rely on authorized access must protect their clients from fraudulent actors. Given that breaking into a bank physically or electronically is typically more difficult than breaking into an individual user's computer, today's bank robbers often specialize in the “last mile” to the end costumers.

In general, bank transactions in a digital environment are facilitated by the establishment of a session between server and client device using secure and encrypted communication protocols, which requires that the user supplies authorization credentials. This is most often based on a username and password and/or a second strong authentication, but it can also be based on biometric solutions such as a fingerprint scan, an iris scan or techniques using continuous behaviometrics in the background. A “user session” for purposes of this disclosure is defined as viewing and downloading of multiple discrete units of information, such as additional packetized data and/or webpages, being loaded on the basis of user input. Examples include a login page, an overview page, action pages, and so on. Each page may have multiple parts thereof such as fields, forms, lists, sliders and buttons for enabling user input.

To get access to data and applications offered by a privileged service provider, such as a banking service provider (BSP), a web-browser or application running on the client's device can be used, and many clients or customers carry out banking transactions via the internet using banking front ends, mostly running on their own devices such as desktop computers, tablets and smartphones. In some cases, for combating fraud and complying with general security directives, every session is logged and stored in a database on a server. The session is typically described by a great number of descriptors, and some of the relevant descriptors are the user agent, meaning browser and software information, device type, and IP address. In prior patents to this invention, behavioral biometrics descriptors with traits of the user behavior, including timings on how the user types or swipes, moves the mouse, and navigates the forms and pages, are logged.

Despite the efforts undertaken to make modern internet-based banking more secure, banking transactions are still vulnerable to the broad threat that modern fraud consists of, from phishing, hacking, and stolen account information to crafty social engineering perfected to lure also quite avid and vigilant users of modern internet banking. In a social engineering fraud, it is often the proper user of the account that is lured to login and perform a transaction on a fraudulent front-end system. Overall, detection of fraud can be a very hard needle-in-a-haystack type of problem, with the added difficulty of not knowing how the needle looks. Attacks constitute a very low number compared to genuine user logins and are often not detected until long after the attack has been completed. Some aspects of an attacker's session descriptors can be faked, or multiple devices and automated scripts may be employed to confuse fraud prevention systems. Existing methods are often plagued by false positives which creates manual work and decreases trust.

What is needed is a way to better detect malfeasance, fraud, and/or a risk of authenticated data sent to a banking user being compromised by a third party.

### SUMMARY OF THE DISCLOSED TECHNOLOGY

A method for a fraud management system (defined as “a combination of devices used to detect fraud and prevent theft of data”) to identify fraudulent behavior (defined as “actions carried out on a computer network via a plurality of network nodes to provide false information or receive information not intended for the receiving party”) is disclosed herein. This includes instructions sent by a server (defined as “a device residing at a network node on a packet-switched network which distributes authenticated and/or encrypted data to a client receiving device at a different network node on the network intended to receive the data after authentication indicating that the client receiving device is authorized to receive the data”). The server distributes content via a packet-switched data network which has been encrypted to a client receiving device (defined as, “a device operated by a user who has been authenticated to receive secure/encrypted/authenticated data”) at a separate network node on the network. The content includes code to be executed (such that instructions in the code are carried out) by the client receiving device to detect fraudulent behavior on the client receiving device. The results of the detection of fraudulent behavior are transmitted back to the server via the packet-switched network based on malfeasant behavior.

In an embodiment of the disclosed technology, a method of denying access to sensitive data is carried out by receiving from each of at least a first end user device and second end user device a version of data based on a recorded session having recorded interactions. The “version” of data is one which is representative of aspects of the original data with the parts thereof needed to carry out the method of the disclosed technology still present in a form which is usable to do same. The recorded interactions include at least one or more of key presses and timing of each key press of the key presses or at least timing of some key presses thereof. The recorded interactions can also include recordation of movements. These movements can include one or more of button presses (which buttons are pressed, when the buttons are pressed in time, and where a screen is pressed and how swiped when using a touchscreen, and so forth). The version of data received is first “sanitized” which is defined as “identifying information of a particular person being removed”. This is accomplished in embodiments of the disclosed technology by anonymizing the key presses.

Once the above steps are carried out, a determination is made that a user generating the interactions on the first end user device is unauthorized. This determination can be made by a system or device carrying out the method of the disclosed technology directly, or by way of receipt of an indication of same (that is, that the data represents a version of a recording of actions to commit fraud) from another entity such as the first end user device or intermediary device which forwarded the data generated at the first end user device. Then, based on similarities of the data received from the first end user device and the second end user device, a determination is made that the user generating the interactions on the first end user device is a same user who generated the interactions on the second end user device.

Once the above determination is made, that the first and second user are the same user, various additional steps are carried out in embodiments of the disclosed technology. Modifying or instructing another to modify further delivery of data to the second end user device can be carried out in order to, for example, prevent further fraudulent activity from being carried out or data from being stolen.

A web server (see definition below) can be employed to receive or send data from the first end user device, such a web server being operated by a banking institution. A “banking institution” is an entity which handles financial transactions between other such institutions or users, and in the below a banking institution is also referred to as an “operator”, meaning an operator of the method in the disclosed technology. It should be understood that “operator” can also refer to a specific legal entity of the banking institution, such as a fraud handling department or an IT department and/or devices operated or under their control in full or in part to carry out methods and other limitations of the disclosed technology. The receiving from the second end user device can also be by way of a web server, this web server being different from the afore-described server and operated by a second banking institution. Each “banking institution” by way of laws in many countries is required to keep user information confidential from each other banking institution. In this method, by sanitizing the information, fraudulent actors can be detected without sharing confidential information.

The delivery of data, described above, to the second end user who is determined to be a fraudulent actor can thus, in embodiments, be modified in real-time. A “fraudulent actor” is one who is believed to be accessing a device which sends/receives data to an operator of the method of the disclosed technology who has carried out fraud, carried out an action which caused one to believe fraud was being carried out, or who has a security breach or potential security breach such as software port in use on their device which is expected to be unused. In another embodiment, the step of receiving a version of data based on the recorded session of the first end user device is carried out only after and as a result of a step of determining that a user generating the interactions on the first end user device is unauthorized.

The above can be carried out as part of post-processing and comparisons made between the users thereof. “Post-processing” for purposes of this disclosure is defined as steps which are carried out after each first and second user has completed their interactions with the respective web servers and/or financial institutions which are part of a recorded interactions indicated to be indicative of fraud or potentially fraudulent behavior. The recorded session of the first end user and a plurality of additional recorded sessions, each with anonymized key presses and timings of movements of a respective motion or touch device are stored on a server and compared as part of post processing thereof in some such embodiments.

Determining that a user generating the interactions on the first end user device is unauthorized is due to, in some embodiments, a (sub-)determination that the recorded session of the first end user device has at least one of: a) keystrokes or timing thereof, b) movements of a motion or touch device, which are used to carry out a fraudulent financial transaction. The combination of the keystroke timing and touch device use can also be used to make the determination. In another embodiment or in combination therewith, the determination that the user device is unauthorized (which should be read as synonymous with determining that the user thereof is a fraudulent actor for purposes of this disclosure) is made by receiving an indication that a particular software port is in use on the first end user device during the recorded session of the first end user device. Other ways of determining unauthorized use are by comparing an inclination angle of the first end user device to the recorded session, output of an accelerometer, or other output provided by such a device. When such output matches between the first user and second user, these can be said to be from the same user.

Described another way, a method of determining that a user of a web server is unauthorized to access a user account despite having a username and password associated therewith is carried out by way of recording timing and entry of at least text and position-related inputs. The text is anonymized and the recording with modified text is sent to a third party server and received thereby. The third party server further receives or generates an indication that the recording matches data associated with a user indicated to have committed or likely to have committed fraud (a “fraudulent actor”). Further delivery of data to the user as a result of the indication is modified. The position-related inputs can include at least one or at least two of a mouse, touch sensor, orientation sensor, gyroscope and accelerometer.

The web server is operated by a first financial institution and the fraud or the likely fraud was committed at a second banking institution based on interaction with a web server operated by the second banking institution in some embodiments. A “banking institution” is differentiated or defined as separate from another such banking institution in some embodiments based on legal requirements which require the institutions to refrain from sharing user data, in some form, with each other.

In some embodiments of the disclosed technology, a determination that the recording matches the data associated with the user indicated to have committed or likely to have committed fraud is made by a third party server which received the recording from the web server and from the second banking institution. In other embodiments, the method is carried out only after an operator of a web server has a suspicion that the user is a fraudulent actor. Such a suspicion can be based on sending executable code from the web server to a device operated by the user to scan software ports and receive a response indicating that a particular software port is already in use. The suspicion can instead or also be based on the user account previously being used to carry out a financial transaction which could not be completed. The suspicion can further or instead be based on an Internet Protocol address of the user of the web server matching that of the user indicated to have committed or likely to have committed fraud, or on a device or software description collected from the end user device matching that of the user indicated to have committed or likely to have committed fraud.

The step of “sending” can be carried out simultaneous to a part of the step of “recording”. The step of “modifying” is further carried out, at least in part, simultaneous to the step of “recording” and the step of “sending” in some embodiments. In other embodiments, the “sending” is carried out after the step of “recording” is complete and/or the step of “modifying” is carried out after a second providing of the username and password to the web server.

A “webpage” for purposes of this disclosure is “a discrete/finite amount of code received via a packet-switched data connection over a network node which has data sufficient to render text and graphics formatted to be viewed by a user” and can have additional data such as code which is executed to change the display or run tasks unknown to the viewer. A “browser” for purposes of this disclosure is “a method or construct which renders code of a webpage and exhibits same to a user.” In some embodiments, a version of code is executed upon or after download of content from each of a plurality of unique uniform resource locators (URL). A “URL” is defined as a string of text which is used to retrieve and/or identifies particular content to be sent/received via a data network. A “web server” is defined as a device which sends a “webpage” or a plurality of webpages to a “browser”.

Any device or step to a method described in this disclosure can comprise or consist of that which it is a part of, or the parts which make up the device or step. The term “and/or” is inclusive of the items which it joins linguistically and each item by itself. “Substantially” is defined as “at least 95% of the term being described” and any device or aspect of a device or method described herein can be read as “comprising” or “consisting” thereof.

### BRIEF DESCRIPTION OF THE DRAWINGS

FIG. 1 shows a high level diagram of devices used to carry out embodiments of the disclosed technology.

FIG. 2 shows a high level chart of steps carried out to determine if an unauthorized user matches a prior unauthorized user accessing a different server in an embodiment of the disclosed technology.

FIG. 3 shows a high level chart of steps used to determined if a user is unauthorized to access a user account in embodiments of the disclosed technology.

FIG. 4 shows a high level block diagram of devices used to carry out embodiments of the disclosed technology.

### DETAILED DESCRIPTION OF EMBODIMENTS OF THE DISCLOSED TECHNOLOGY

Two user-authenticated sessions are compared between two different servers or users of two different financial institutions. Based on comparisons of sanitized key press timings, position or motion-related inputs, and other inputs it is determined that the sessions were/are with a same user. When this user is identified as a fraudulent actor or malfeasant with one server or banking institution, this data is shared, without sharing confidential information, with the other server or financial institution so that despite a lack of identifying the user himself/herself, the second server or financial institution can modify data sent to this user to prevent fraud and unauthorized access to data of having private data about another person.

Embodiments of the disclosed technology will become more clear in view of the following description of the figures.

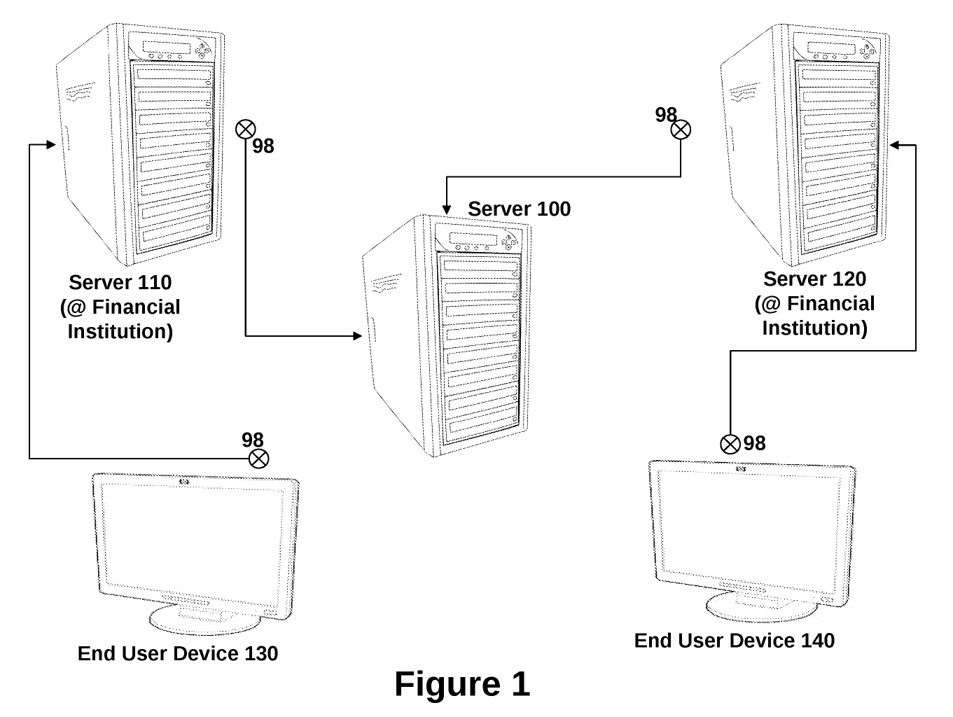

FIG. 1 shows a high level diagram of devices used to carry out embodiments of the disclosed technology. Here, the servers 110 and 120 send content over a network, such as a distributed wide area network which lacks ownership by any one individual or entity such as a packet-switched network with a series of hubs, switches, and routers connecting end user devices. Such a network, in embodiments of the disclosed technology is known as the “Internet”. The services are connected at network nodes 98 (physical devices which allow for an electrical or wireless electrical connection to the wide area network), each at a different such node. The servers 110 and 120 are, in embodiments of the disclosed technology, operated by separate companies, at separate network nodes, and are bound by law to keep from one another at least some data received from respective end user devices 130 and/or 140 and other end user devices used to send data to either of the servers 110 or 120.

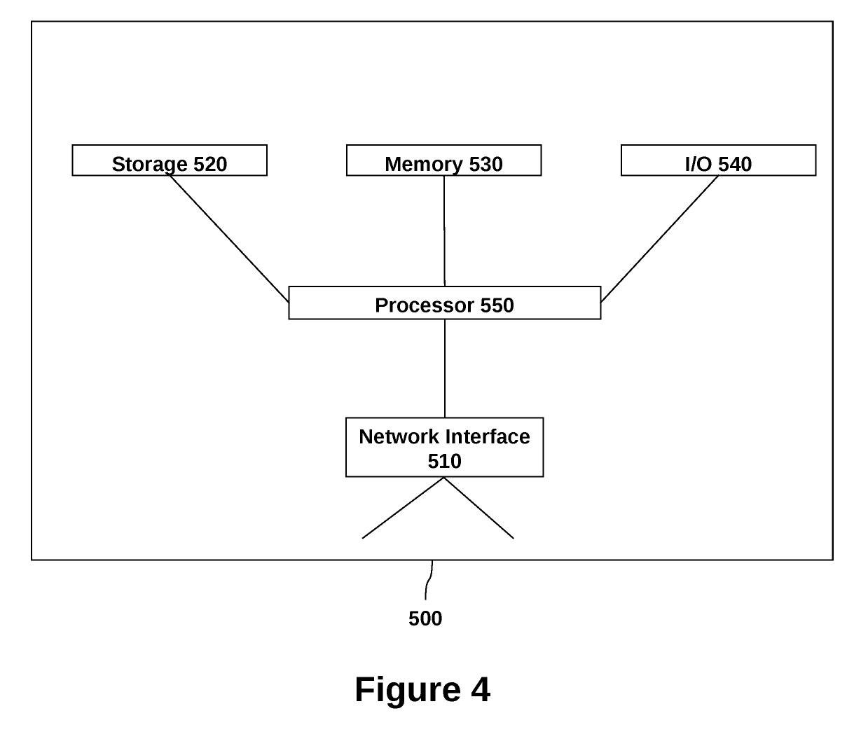

The end user devices 130 and 140 have secure packetized data network connections with the servers 110 and 120, respectively and as shown in the Figure. It should be understood that each server and end user device can be representative of multiple such devices and servers. The server 100, in embodiments of the disclosed technology, has a data network connection over a packet-switched data network with the servers 110 and 120. In embodiments of the disclosed technology, no data is directed from the end user devices 130 or 140 to the server 100 or from the server 100 to either of the end user devices 130 or 140. Each of these devices has the elements shown with reference to FIG. 4 and connects via a packet switched data network to at least one other of the devices.

A malfeasant, a fraudulent actor, or an unauthorized user is one who is attempting to commit a fraudulent act, steal data or information not intended for same, or who has been indicated as carrying out suspicious behavior which may be indicative of same. In embodiments of the disclosed technology, information about such a user can be recorded and shared between servers 110 and 120 via server 100 while overcoming a difficulty of laws which prevent the sharing of personal information about another by removing or anonymizing such information. When the server 110 delivers content to the end user device 130, this can be secure content intended only for an authenticated user of the end user device 130.

The end user device 130 carries out instructions that when executed, collects and characterizes the behavior of the authenticated user of the end user device 130. Such instructions are included in the content delivered by server 110 and represent methods that perform continuous authentication of the user during the session. The behavioral characteristics are defined as statistical measures of at least one or a plurality of key press times, key flight times, mouse movement, device description, user agent (meaning operating system, browser type, model, and version), screen refresh rate, pressure sensor readings and more.

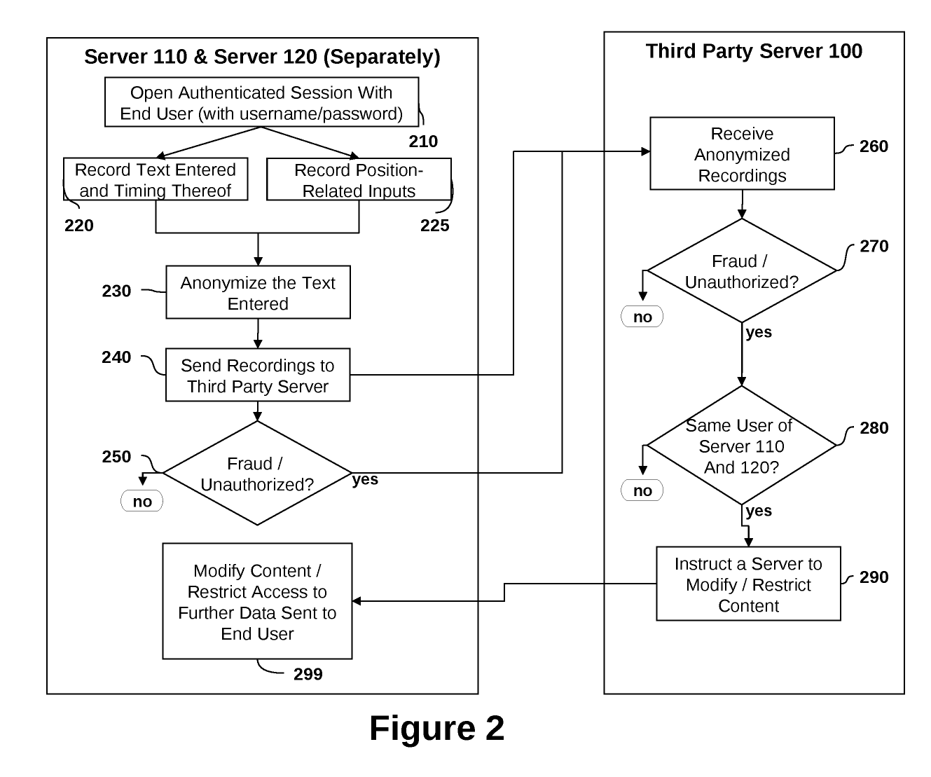

FIG. 2 shows a high level chart of steps carried out to determine if an unauthorized user matches a prior unauthorized user accessing a different server in an embodiment of the disclosed technology. Each of servers 110 and 120 carry out the steps in the left box independently from one another in embodiments of the disclosed technology. At least one server carries out all of the steps while in some embodiments only one server 110 or 120 carries out step 299. The third party server 100 carries out the steps in the large right box of FIG. 2, interacting with the servers 110 and 120. It should further be understood that servers 110 and 120 can carry out the steps simultaneously for many users of devices such as devices 130 and 140 and/or at different times, using data previously received from a prior user session with either or both of the servers 110 and 120. This will become more clear in view of the description of the steps shown in FIG. 2.

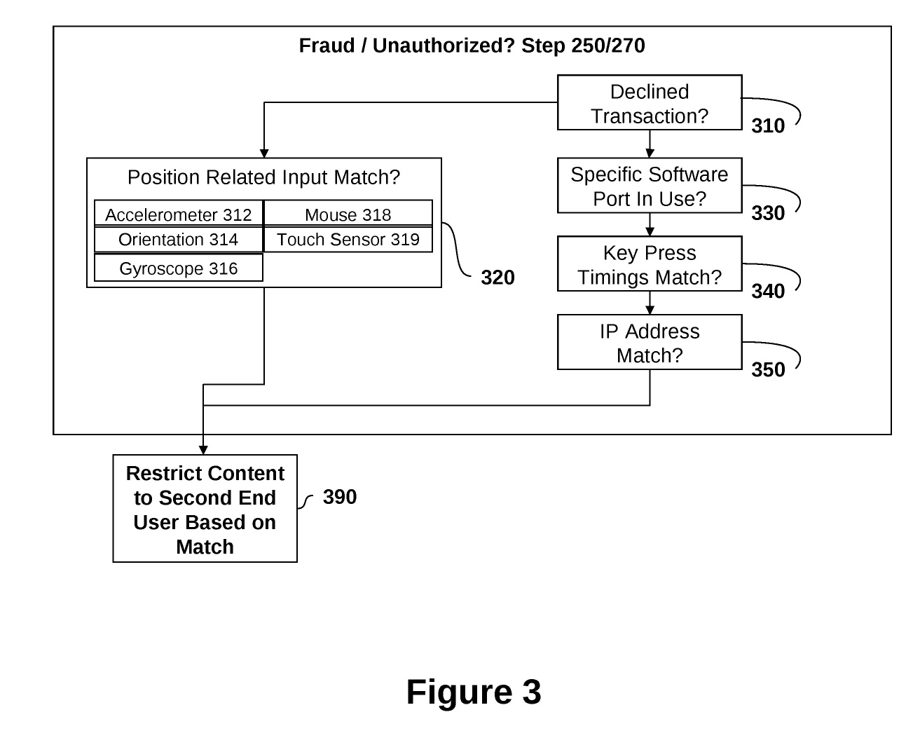

Discussing first the left box, the steps carried out by one or both servers 110 and 120, an authenticated session is opened with an end user in step 210. This can be based on receipt of a username and password or other mechanism of authentication from an end user device including biometric data such a finger print or iris scan. Once authenticated the data between the server 110 or 120 and the end user device is recorded in steps 220 (recording of text entered and timing of entry) and 225 (recording of position-related inputs). The position-related inputs are discussed in more detail in step 320 of FIG. 3. Returning now to the discussion of FIG. 2, the steps 220 and 225 can be carried out by way of a script executed on the end user device, such as device 130 or 140, delivered with a web page from the server 110 or 120 and/or based on data received from an end user device to one of the servers. This data, however, can have there-within sensitive data about an end user bank account, name, IP address, and other personal data. The movement of position-related inputs are, in embodiments of the disclosed technology, free of such personally identifiable data and the data received from a fraudulent actor is unprotected by confidentiality rules in many locations. However, even a fraudulent actor could be providing data which is representative of a person's personal information, even if fraudulently obtained. As such, in step 230 the data which is recorded which could or does identify a person and/or is confidential is changed. Text received by the end user device and/or server 110 or server 120 is sanitized, randomized, encrypted, or otherwise changed (herein, each of these methods are referred to as being “anonymized”). In some embodiments, step 230 includes deterministically encrypting session information to provide traceability without disclosing personal information. In such an embodiment, said session information comprises an IP address, device hardware information (data unique to a specific physical device such as a MAC address, processor ID, or serial number), and device software information such as an operating system and web browser version, banking front end, user agent and the like. One such method for deterministically encrypting session information is to apply a hash algorithm or encryption method per substring of session information text without changing the random seed, defined as the number used for initializing a pseudorandom number generator in the encryption algorithm, between appliances, which produces the same hashed symbol per given input character or set of characters. In one embodiment, the seed is different between servers 110 and 120 such that in the case they both encounter and encrypt the same original characters or substrings, the resulting encrypted/hashed versions of the session information have different symbols when sent by server 110 and 120 in step 240 and received in step 260 by the third party server 100. The patterns of occurrences can be counted and compared between two or more hashed recordings. This provides some further matching data between received encrypted session information text. In another embodiment, the servers 110 and 120 employ the same seed, making a direct comparison between encrypted versions of the session information possible and allowing fraud cases to be found with higher probability. No matter the chosen method of seed handling, the server 100 is generally unable to decrypt the symbols into the original characters. Thereby, the method is keeping personal information safely protected at servers 110 and 120 while greatly increasing the precision for determining fraud using the comparison at server 100, in step 270, and in step 280 helping to determine if the user is the same as another user, more of which is elaborated on below.

While the text is anonymized, the timings of the text being entered are preserved in the recording from step 220. The now anonymized data received about the end user and/or end user device are, in step 240, sent to the third party server 100, a device operated from a different network node on the network and which, in some embodiments, does not have communication about the authenticated session directly sent between itself and an end user device thereof. The third party server receives the anonymized recording in step 260 from a plurality of servers, such as servers 110 and 120 based on separate recordings of separate user sessions. A “user session” is the set of data sent and received between an end user and a server during a time when private data is authorized to be communicated there-between based on authenticating the identity of an end user, such as described with reference to step 210.

In either step 250 or step 270 it is determined if the user session comprises or comprised unauthorized or fraudulent actions. That is, this determination can be made by either a server 110/120 or operator thereof or by the third party server 100. In an example of when the server 110 makes this determination in step 250, this can be as a result of determining that a software port is in use which is one which indicates an unauthorized user has access to the data. In another example, a financial institution operating the server 110 can determine after the recording was carried out that the recording includes a fraudulent transaction such as an illegitimate transfer or an illegitimate payment. The determining that a transfer or payment is illegitimate, is a determination in embodiments of the disclosed technology which is made according to pre-inputted instructions based on actions carried out by a user of a banking system and/or by a person making such a determination based on at least one of the following: attempts to transfer funds to a country the user never have transferred to before, using blacklisted account numbers in the addressee, trying to cause a transaction to take place while routing data through a VPN (virtual private network), and/or attempting to make a transaction which fails. In examples of where the third party server makes the determination, this can be based on, for example, the recordings matching that of other recordings which were indicated as fraudulent such as where there are matches between, typing speed and press/flight characteristics, how a touchscreen interface was interacted with, the angle in which the end user devices were held with and so forth. The determination can also be based on the anonymized session information as described above. Where no fraud or unauthorized use is determined in step 250 or 270, the method stops with regard to the particular session (though can continue to record new sessions or receive new data about additional user sessions and repeat the steps of FIG. 2).

When a determination has been made that a user session and/or authenticated session which has been recorded is fraud/unauthorized, then it is determined if another session, in step 280, by way of its recording, was with an end user operated by a same fraudulent actor. Here, the “fraudulent actor” can be a human being, a bot (computing device carrying out instructions which are intended to appear as if the instructions were carried out by a human being), or other. For purposes of this disclosure, “recording” refers to storing a version of the same of the data received from an end user and/or end user device during the authenticated session. Described another way, two different user sessions which are recording between two different servers which cannot, by laws of the country they operate in, share confidential data with each other interact with a user via a same or two different end user devices. In at least one of these cases, in an embodiment of the disclosed technology, a user operating an end user device or an end user device is determined to have been used to carry out a fraudulent transaction or information about the device's operation raises a concern that a fraudulent action is being carried out or confidential data has been compromised. Each of these cases are simply referred to as being “fraudulent” or “unauthorized” for convenience in nomenclature.

Based on such a determination, step 290 is carried out with respect to the second user, user session, or end user device which matches that of the fraudulent user or user device. As such, a server 110 or 120 is instructed about the possibility that an end user thereof is a fraudulent actor or unauthorized in step 290 and in step 299, a server modifies content sent to the end user to restrict access to data or otherwise modify the content to prevent further fraud from occurring. In some embodiments, a server where the fraud is detected is different from a server which modifies content and each of these servers can be operated by a separate financial institution. The step 299 can be carried out while the end user suspected of fraud is in an authenticated session with a respective server or when a later authenticated session is opened between the user using the authentication information (e.g. username and password) whether opened with the same server (including one operated by the same entity) or with a different server (such as one operated by yet a third financial institution).

FIG. 3 shows a high level chart of steps used to determine if a user is unauthorized to access a user account in embodiments of the disclosed technology. This figure shows in more detail the step 250 and 270 of FIG. 2. A fraudulent or unauthorized transaction can be determined based on a transaction being declined in step 310. That is, a transaction which in some way is intended to move funds from one account to another account or one entity to another entity which fails, for whatever reason, can be indicative of fraudulent activity and flagged as such causing a “yes” or positive determination to step 250 and/or 270. Still further, a software port which is in use on an end user device which is expected to be available or used by a fraudulent actor can trigger such a determination in step 330. The parent case describes this in more detail which is incorporated by reference due the priority claim. The key press timings matching that of a known fraudulent user/actor or bot in step 340 can also be cause for determining that a recorded session is of a fraudulent user. In such an embodiment, then a match can be made to another recorded session by way of one of the other mechanisms of comparison shown in FIG. 3. This three-way (transitive property) comparison between different sessions and actions can be made by combining any of the steps shown in FIG. 3, and any of the steps may be performed independently of the others.

A matching between symbols of encrypted/hashed IP (internet protocol address based on IPv4 or IPv6) or device/software description in step 350 is another such characteristic that can be used to match user sessions and find fraudulent actions. Further, the comparison of position related inputs in step 320 can be a basis for same. Such inputs can be from an accelerometer 312, mouse 318, touch sensor 319, orientation sensor 314, or gyroscope 316 each of which provide data about how an end user interacts with an end user device including based on orientation in which the device is held, how hard and fast one swipes, moves the device, shakes the device, and the like. Sensor misalignment, floating point calculation errors in CPU or GPU, display characteristics, sound recording and replaying fidelity, and other similar discrepancies which help identifying a specific device can also be used in embodiments of the disclosed technology.

Finally, in step 390 of FIG. 3, content to a second user is restricted based on the matching of data from two different user sessions to two different servers is carried out.

FIG. 4 shows a high level block diagram of devices used to carry out embodiments of the disclosed technology. Device 500 comprises a processor 550 that controls the overall operation of the computer by executing the device's program instructions which define such operation. The device's program instructions may be stored in a storage device 520 (e.g., magnetic disk, database) and loaded into memory 530 when execution of the console's program instructions is desired. Thus, the device's operation will be defined by the device's program instructions stored in memory 530 and/or storage 520, and the console will be controlled by processor 550 executing the console's program instructions. A device 500 also includes one or a plurality of input network interfaces for communicating with other devices via a network (e.g., the internet). The device 500 further includes an electrical input interface. A device 500 also includes one or more output network interfaces 510 for communicating with other devices. Device 500 also includes input/output 540 representing devices which allow for user interaction with a computer (e.g., display, keyboard, mouse, speakers, buttons, etc.). One skilled in the art will recognize that an implementation of an actual device will contain other components as well, and that FIG. 4 is a high level representation of some of the components of such a device for illustrative purposes. It should also be understood by one skilled in the art that the method and devices depicted in FIGS. 1 through 3 may be implemented on a device such as is shown in FIG. 4.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described herein-above are also contemplated and within the scope of the disclosed technology.

I claim:

1. A method of denying access to sensitive data, comprising the steps of:
receiving from each of at least a first end user device and second end user device:
a version of data based on a recorded session comprising recorded interactions, said recorded interactions including at least:
key presses and timing of each key press of said key presses; and
movements, including at least one of button presses, motion, and timing of said button presses and motion thereof;
wherein said version of data received has been sanitized by anonymizing said key presses;
determining that a user generating said interactions on said first end user device is unauthorized;
determining, based on similarities of said data received from said first end user device and said second end user device, that said user generating said interactions on said first end user device is a same user of generating said interactions on said second end user device.

2. The method of claim 1, wherein based on said determining that said first user and said second user are a same user, modifying or instructing another to modify further delivery of data to said second end user device.

3. The method of claim 2, wherein:
said receiving from said first end user device was by way of a first web server operated by a first banking institution;
said receiving from said second end user device was by way of a second web server operated by a second banking institution; and
said further delivery of data is modified in real-time while said second end user attempts to access secure data from said second web server.

4. The method of claim 1, wherein said step of receiving a version of data based on said recorded session of said first end user device is carried out only after and as a result of said step of determining that said user generating said interactions on said first end user device is unauthorized.

5. The method of claim 4, wherein said recorded session of said first end user and a plurality of additional recorded sessions comprising anonymized key presses and timings of movements of a respective motion or touch device are stored on a server and compared as part of post processing thereof.

6. The method of claim 4, wherein said determining that a user generating said interactions on said first end user device is unauthorized is due to a determination that said recorded session of said first end user device comprises at least one of keystrokes and movements of a motion or touch device used to carry out a fraudulent financial transaction.

7. The method of claim 1, wherein said determining that a user generating said interactions on said first end user device is unauthorized is due to a determination that a specific software port is in use on said first end user device during said recorded session of said first end user device.

8. The method of claim 4, wherein said determining that said user generating said interactions on said first end user device is unauthorized is based on a determination that an illegitimate transfer was performed.

9. The method of claim 1, wherein an inclination angle of said first end user device is included in said recorded session thereof and compared in said step of determining that said second user device is being operated by said same user as that of said first user device.

10. The method of claim 1, wherein deterministically encrypted session information from said first end user device is included in said recorded session thereof and compared in said step of determining that said second user device is being operated by said same user as that of said first user device.

11. A method of determining that a user of a web server is unauthorized to access a user account despite having a username and password associated therewith, said method carried out by:
recording timing and entry of at least text and position-related inputs;
anonymizing said text;
sending said recording modified by said anonymizing to a third party server;
receiving an indication that said recording matches data associated with a user indicated to have committed or likely to have committed fraud;
modifying further delivery of data to said user as a result of said indication.

12. The method of claim 11, wherein said position-related inputs include at least two of a mouse, touch sensor, orientation sensor, gyroscope and accelerometer.

13. The method of claim 11, wherein said web server is operated by a first financial institution and said fraud or said likely fraud was committed at a second banking institution based on interaction with a web server operated by said second banking institution.

14. The method of claim 13, wherein a determination that said recording matches said data associated with said user indicated to have committed or likely to have committed fraud is made by a third party server which received said recording from said web server and from said second banking institution.

15. The method of claim 11, wherein said step of sending is carried out only after an operator of a web server has a suspicion that said user is a fraudulent actor.

16. The method of claim 15, wherein said suspicion is based on sending executable code from said web server to a device operated by said user to scan software ports and receiving a response indicating that a particular software port is already in use.

17. The method of claim 15, wherein said suspicion is based on said user account previously being used to carry out a financial transaction which could not be completed.

18. The method of claim 11, wherein said step of sending is carried out simultaneous to a part of said step of recording.

19. The method of claim 18, wherein said step of modifying is further carried out, at least in part, simultaneous to said step of recording and said step of sending.

20. The method of claim 11, wherein said step of sending is carried out after said step of recording is complete and said step of modifying is carried out after a second providing of said username and said password to said web server.

21. The method of claim 15 wherein said suspicion is based on deterministically anonymized session information of said user of said web server matching that of said user indicated to have committed or likely to have committed fraud.
